(19) United States
(12) Patent Application Publication
(10) Pub. No.: US 2015/0076787 A1
(43) Pub. Date: Mar. 19, 2015

(54) RECUMBENT HUMAN POWERED VEHICLE WITH A RECIPROCATING LINEAR DRIVE

(71) Applicant: Michael Kipnis, Oklahoma City, OK (US)

(72) Inventor: Michael Kipnis, Oklahoma City, OK (US)

(21) Appl. No.: 14/482,622

(22) Filed: Sep. 10, 2014

Related U.S. Application Data
(60) Provisional application No. 61/877,562, filed on Sep. 13, 2013.

(51) Int. Cl. B62M 1/28; B62K 3/00

(52) U.S. Cl. CPC B62M 1/28; B62K 3/005
USPC 280/251

(57) ABSTRACT

A recumbent human-powered vehicle is propelled by a reciprocating thrust motion using a linear drive mechanism connected by flexible power links to a double overrunning clutch transmission with returning springs. The vehicle has a wheel base approximately that of a conventional upright bicycle and does not utilize a crank transmission. The vehicle may be propelled with alternating, single or simultaneous leg motion with the use of pedal sliders positioned for independent pendulum-type oscillation. The linearly reciprocating pedals are rotationally linked to the transmission portion of the linear drive mechanism through a pair of flexible power links so as to transfer power from the pedals to the transmission, which includes a pair of overrunning clutches connected to the main chain axis allowing to transmit the moving force to the main chain axis. The overrunning clutches return back to idle mode with the use of returning springs.

### BACKGROUND OF THE INVENTION

1. Field of the Invention

This invention is generally related to recumbent human-powered vehicles such as bicycles, tricycles and other multi-wheel variants that are propelled by a reciprocating thrust motion of the operator using a linear drive mechanism connected by a flexible power link to a double overrunning clutch transmission with returning springs. The human-powered vehicle is propelled with the use of pedals which are positioned approximately above and on either side of the front wheel to create a short wheel base in the human-powered vehicle, with the seat located between the front and rear wheels. The human-powered vehicle may be propelled with the thrust motion of one leg, both legs in an alternating motion such as a typical crank-shaft bicycle, or with the use of both legs simultaneously.

2. Description of the Prior Art

Recumbent human-powered vehicles such as bicycles and tricycles and human-powered vehicles with linear drivers are known in the prior art. Some examples of such art are found in U.S. Pat. Nos. 4,878,684; 5,979,922; 5,732,963; 5,290,054; 5,915,710; 7,048,290 B2; and WO 2006/002577. Indeed, various bicycle systems and rider positions have been proposed in the art in an effort to provide a rider position that is both comfortable and utilitarian. For example, rectilinear pedal drive systems having two drive chains and an upright rider position are known in the art. Such a system has a separate, vertically-oriented structure mounted to a bicycle frame for supporting and guiding the pedals when in an upright riding position. Recumbent human-powered vehicles with pivotally mounted pedals movable along an arcuate motion have been proposed. Other prior pedal drive systems use interconnected pedals that allow only alternating pedal motion, while other systems allow for both pedals to move forward and rearward together. For reasons provided below, these examples of human-powered vehicles are deficient when compared to the present invention.

U.S. Pat. No. 4,878,684 (“the '684 patent”) discloses a recumbent bicycle with a crank transmission, which has certain disadvantages when compared to the present invention, including, for example, lower efficiency, crank kick-backs and crank getting stuck. The recumbent bicycle of the '684 patent has the pedals in front of the seat, with both the seat and pedals being positioned along the frame of the bicycle between the rear and front wheels. Due to this positioning, the '684 patent bicycle has a wheel base that is substantially longer than one of a conventional upright bicycle. The increased length and resultant weight make such a bicycle difficult to maneuver and slower than either conventional bicycles or the human-powered vehicle disclosed in the present invention. A shorter wheel base and lighter human-powered vehicles are desirable. In addition, as explained below, the crank transmission of the '684 patent provides only 24% or less muscle efficiency. Such inefficiency is too low, especially for a larger, heavier vehicle described in the '684 patent. To overcome the disadvantages of crank-operated recumbent bicycles such as those described in the '684 patent, it is desirable to utilize linearly reciprocating pedals positioned in front of the front wheel of the human-powered vehicle, as shown further below.

U.S. Pat. No. 5,979,922 (“the '922 patent”) describes a recumbent bicycle with a linear drive mechanism and a partially linearly reciprocating pedal motion; however, when compared to the present invention, the bicycle of the '922 patent has many disadvantages. First, due to the length of the pedal sliders described in the '922 patent, the wheel base of the resulting bicycle is substantially longer than of a conventional bicycle. Thus, similar to the '684 patent, the bicycle of the '922 patent is both long and heavy and suffers from the same disadvantages as the '684 patent bicycle. Moreover, the design described in the '922 patent has a potential problem with stability and requires retractable stabilizer wheels, which make this design dangerous and impractical for most riders. Indeed, the aforementioned disadvantages are typical of most recumbent bicycles known in the art. The presently described invention addresses this known problem with a wheel base equal to or only slightly longer than a conventional upright bicycle. Such a design, coupled with the novel drive mechanism proposed herein, eliminates the problems associated with a long wheel base. Second, the recumbent bicycle of the '922 patent does not allow for independent pedal motion wherein the rider chooses simultaneous or alternating pedal motion, which may be powered by a rider having only one leg. Finally, the '922 patent lacks in power efficiency provided with the use of the novel linear drive mechanism connected by a flexible power link to a double overrunning clutch transmission with returning springs.

Additional prior art references accumulate many of the problems described above. These include U.S. Pat. Nos. 5,732,963; 5,290,054; 5,915,710; and 7,048,290.

Therefore, a need in the art exists for an efficient recumbent human-powered vehicle with a wheel base approximately that of a conventional upright bicycle, low weight and convenient seating and steering, and that may be operated with a simultaneous thrust motion of both legs, alternative thrusts of either leg, or with one leg only. A further need in the art exists for a human-powered vehicle as an alternative to automobiles and other form of transit. The present invention fulfills these and other needs by providing a short wheel base recumbent human-powered vehicle propelled by a reciprocating thrust motion of the operator using a linear drive mechanism connected by a flexible power link to a double overrunning clutch transmission with returning springs.

### SUMMARY OF THE INVENTION

Accordingly, it is an object of the present invention to provide a recumbent human-powered vehicle propelled by a reciprocating thrust motion of the operator using a linear drive mechanism connected by flexible power links to a double overrunning clutch transmission with returning springs. The human-powered vehicle is propelled with the use of pedals, which are positioned approximately above and on either side of the front wheel to create a short wheel base, approximately the same or slightly larger than that of a conventional upright bicycle, with the seat located between the front and rear wheels. The human-powered vehicle generally comprises a frame supporting a rider in a substantially recumbent position, a driven wheel rotatably mounted on the frame, a drive gear for driving the driven wheel, left and right pedals mounted on the front of the frame in front of the steering column, with the right and left pedals reciprocally traveling in a substantially horizontal rectilinear path. The top extremities of a pair of pedal sliders are positioned for independent pendulum-type oscillation in a pedal-slider bracket, which is connected to a frame through a front bracket. The linearly reciprocating pedals are attached to the lower extremity of the pedals sliders and are rotationally linked to the linear drive mechanism through a pair of flexible power links such as chains or flexible cords so as to transfer power from the pedals to the diver mechanism. The linear drive mechanism is located between the wheels, and the recumbent seat is located on the beam in front of or between the rear wheel(s) and the steering column. The drive mechanism is connected to the vehicle main chain axis drive/transmission, which is connected to the frame and includes a pair of sprocket wheels connected a pair of overrunning clutches allowing transmission of the moving force to the main chain axis and returning back as overrunning clutches in idle mode. To return the flexible power links and pedals back to a working position, the flexible power links are connected to a pair of linear springs, which are connected to the vehicle frame. Alternatively, the flexible power links may be returned to original or working position by spiral torsion springs, which are also connected to the flexible power links and the vehicle frame. The pedals execute a back-and-forth motion between a fully extended and a contracted position. Unlike other recumbent human-powered vehicles, the present invention does not utilize a crank transmission and may be propelled with the thrust motion of one leg, both legs in an alternating motion such as a typical bicycle using a crank mechanism, or with the use of both legs simultaneously.

The human-powered vehicle of the present invention has a very efficient power transfer to the wheels, thereby increasing the speed of the vehicle as compared to typical recumbent bicycles and tricycles, permitting a greater speed and distance of travel, and allowing to carry additional weight, such as, for example, extra passengers. Typical crank-operated human-powered vehicles such as bicycles and tricycles are capable of only 24% muscle efficiency (see, e.g., Efficiency Measurements of Bicycle Transmissions—A Neverending Story, Bernhard Rohloff and Peter Greb, Human Power, 55, 11-15 at 13—attached as addendum A, expressly incorporated herein by reference) as compared to the novel linear drive and double-overrunning clutch transmission utilized in the present invention, which use approximately 90% or higher muscle efficiency. The increased efficiency, relatively lighter weight, comfort and ease of steering of the human-powered vehicle described herein, make it as an alternative to fuel-consuming vehicles for local travel and transport of lighter weight loads.

A particular feature of the recumbent position and frame of the vehicle described herein is a riding position that, compared with the upright seated position, affords more efficient and comfortable propulsion, where muscle stress may be more readily alternated among muscles groups of both the front and back of the body. The recumbent position of the seat in the present invention offers additional medical benefits that are well-known and described in the art of recumbent cycling, such as, for example, decreased pressure on the groin area.

Due to the relatively short wheel base of the present invention and its unique linear drive transmission, the human-powered vehicle of the present invention is generally capable of attaining speeds substantially higher than those of conventional crankshaft-operated recumbent bicycles and tricycles. The combination of the design with a short wheel base and the linear drive mechanism described herein also permits the user of the vehicle to propel heavier loads, such as additional passengers, groceries, and other weight.

Further objects and advantages of this invention will become apparent from a consideration of the included figures with corresponding description.

### DESCRIPTION OF THE DRAWINGS

FIG. 1 is a perspective view of an embodiment of the present invention.

FIG. 2A is a perspective view of the linear drive mechanism and a particular embodiment of the flexible power link—a vinyl-coated metal cord—used in the present invention.

FIG. 2B is a perspective view of the linear drive mechanism and a particular embodiment of the flexible power link—a metal chain—used in the present invention.

FIG. 3A is a cross-sectional view of a particular embodiment of the transmission of the present invention (utilizing drums and cord as a flexible power link).

FIG. 3B is a side view of a particular embodiment of the transmission and linear drive mechanism of the present invention (utilizing drums and cord as a flexible power link).

FIG. 4A is a cross-sectional view of a particular embodiment of the transmission of the present invention (utilizing sprocket wheels and chain as a flexible power link).

FIG. 4B is a side view of a particular embodiment of the transmission and linear drive mechanism of the present invention (utilizing sprocket wheels and chain as a flexible power link).

TABLE 1
Figures Reference

| Number Reference | |
|---|---|
| In Figures | Part |
| 1 | Linear drive recumbent |
| | human-powered vehicle |
| 2 | Frame |
| 3 | Rear wheel |
| 4 | Top tube |
| 5 | Low tube |
| 6 | Steering column |
| 7 | Pedal slider bracket |
| 8 | Right pedal slider |
| 9 | Left pedal slider |
| 10 | Right power link |
| 11 | Left power link |
| 12 | Front wheel |
| 13 | Transmission/main chain axis |
| | drive |
| 14 | Main drive sprocket wheel |
| 15 | Main drive chain |
| 16 | Rear wheel drive sprocket wheel |
| 17 | Adjustable handlebar |
| 18 | Seat |
| 19 | Linear drive mechanism |
| 20 | Flexible power link |
| | (vinyl-coated metal cord) |
| 21 | Flexible power link (metal chain) |
| 22 | Front fork |
| 23 | Pedal slider bracket holder |
| 24 | Transmission bracket |
| 25 | Seat support rod |
| 26 | Transmission axle |
| 27 | Overrunning clutch outer ring |
| 28 | Overrunning clutch inner ring |
| 29 | Linear returning spring |
| 30 | Spiral torsion returning spring |
| 31 | Bearing |
| 32 a, b | Sprocket |
| 33 a, b | Drum |
| 34 | Power stroke cycle |
| 35 | Return stroke cycle |
| 36 | Human power/muscle force |
| 37 | Pedals |

### DETAILED DESCRIPTION OF THE INVENTION

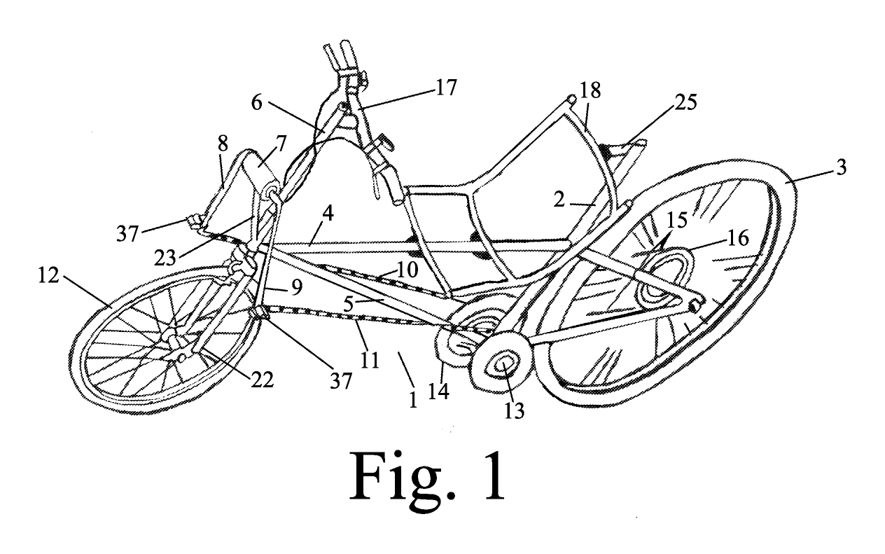

Referring to FIGS. 1-3, in one embodiment of the present invention, a recumbent bicycle 1 has a double-stroke linear drive mechanism 19 integral with a bicycle frame 2. The recumbent bicycle 1 has many of the standard components found in typical bicycles, such as a rear wheel 3, top tube 4, low tube 5, steering column 6, front wheel 12, main drive sprocket 14, main drive chain 15, rear wheel drive sprocket 16, adjustable handlebar 17, front fork 22.

Bicycle 1 is provided with a right pedal slider 8 and left pedal slider 9, with the upper ends of the pedal sliders 8 and 9 joined in a pedal slider bracket 7 of a pedal slider bracket holder 24 of frame 2 to create a pendulum-type oscillation movement. Pedals 37 are attached to the lower ends of each of the pedal sliders 8 and 9.

Bicycle 1 is provided with a drive mechanism 13, which is positioned for rotation in a transmission bracket 24 of frame 2. A right power link 10 and a left power link 11 are each attached to the lower ends of pedal sliders 8 and 9.

Seat 18 of the recumbent bicycle 1 is adjustably attached to frame 2 to tube 4 and has adjustable seat support rod 25. Although in a preferred embodiment of the present invention, seat 18 is substantially recumbent, this position need not be completely horizontal in relation to tube 4, the pedals 37 and drive mechanism 13. A rider position below or above the horizontal plane defined by the drive mechanism may also work with the human-powered vehicle of the present invention. In certain embodiments, it may be beneficial to raise the seat 18 above the plane defined by the drive mechanism 13 for better visibility of the vehicle operator.

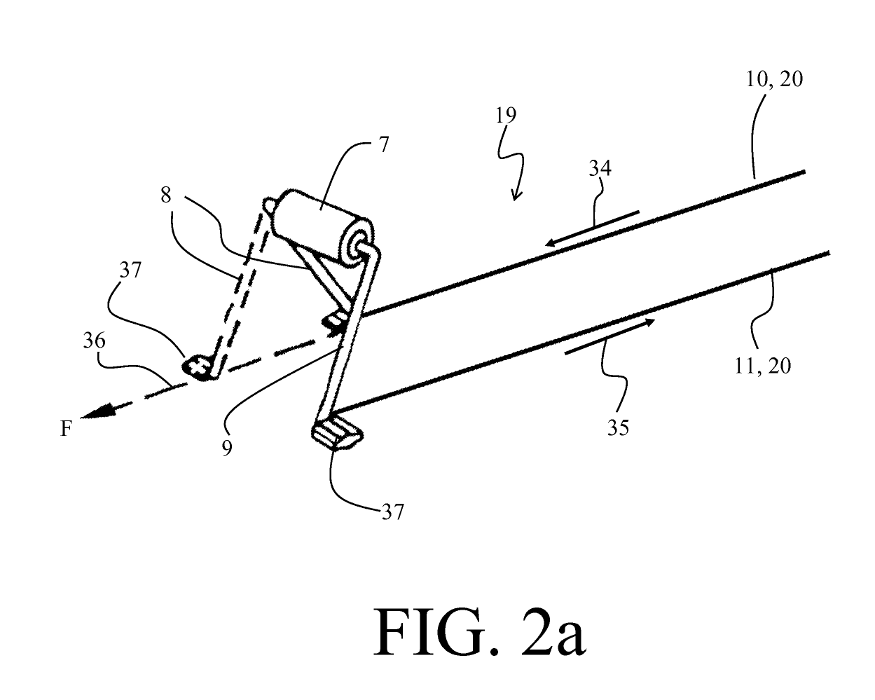

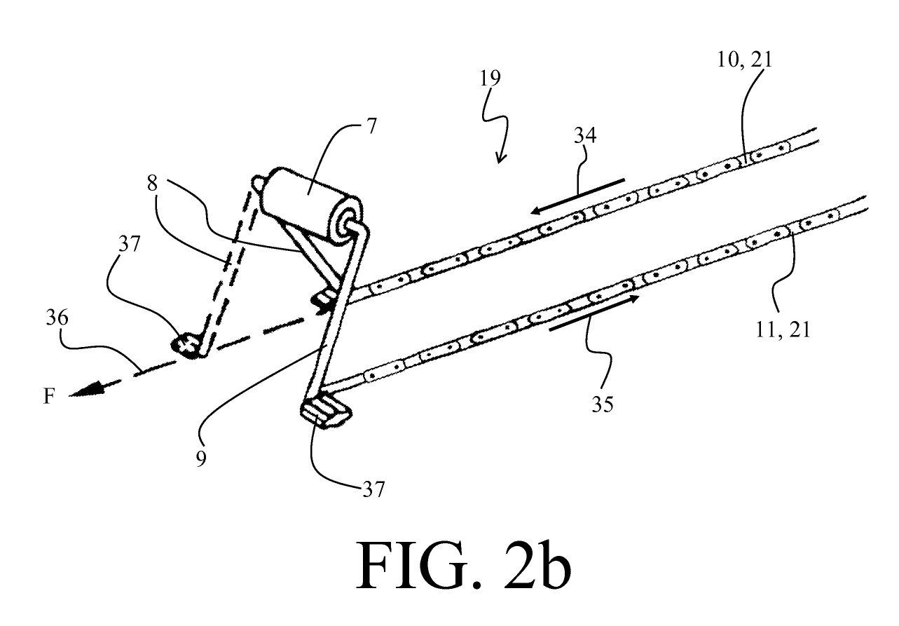

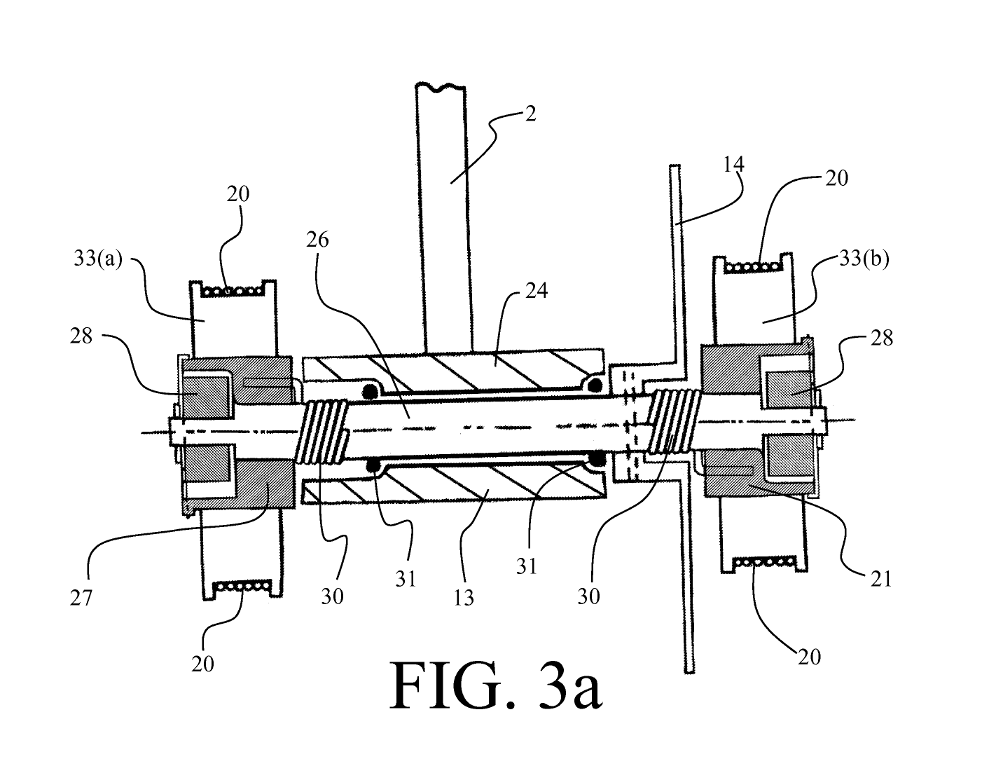

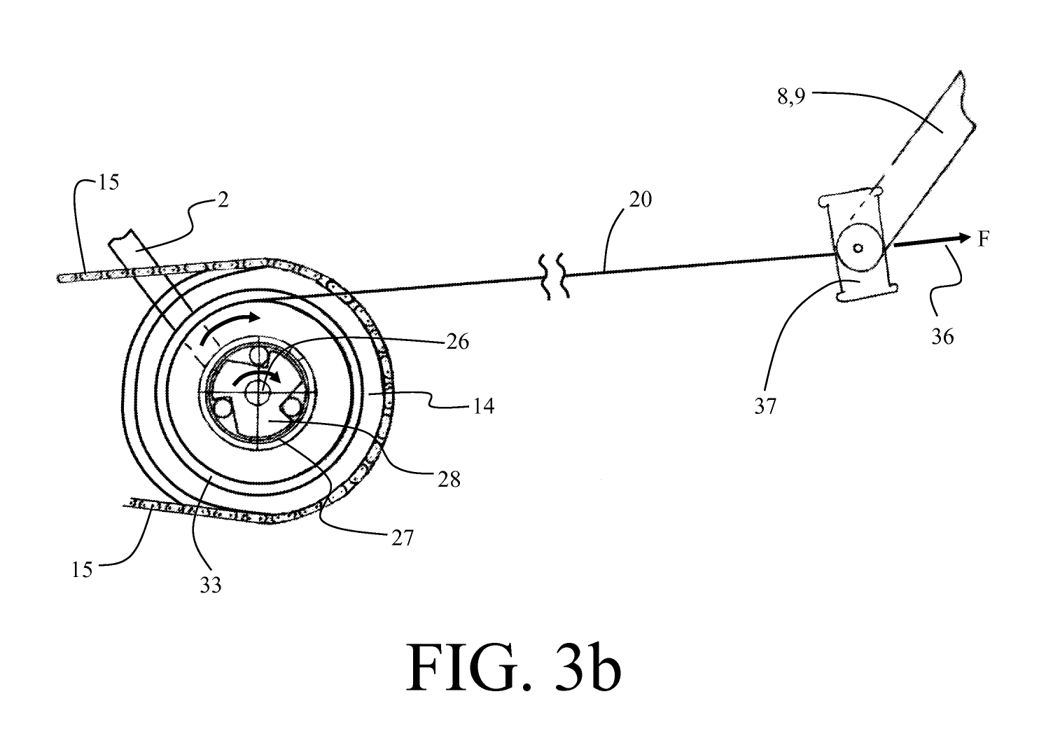

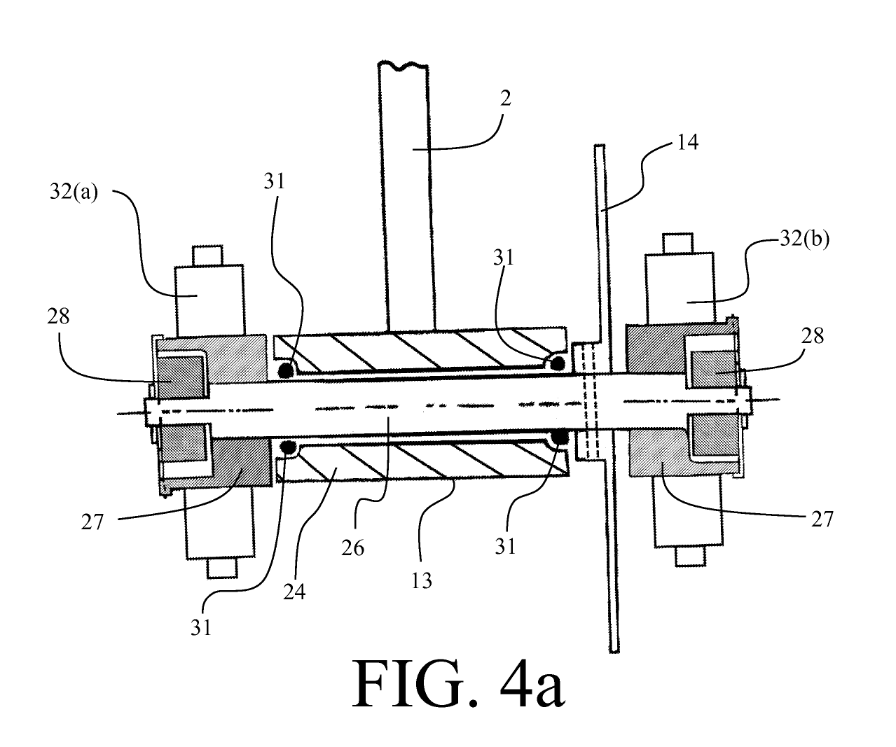

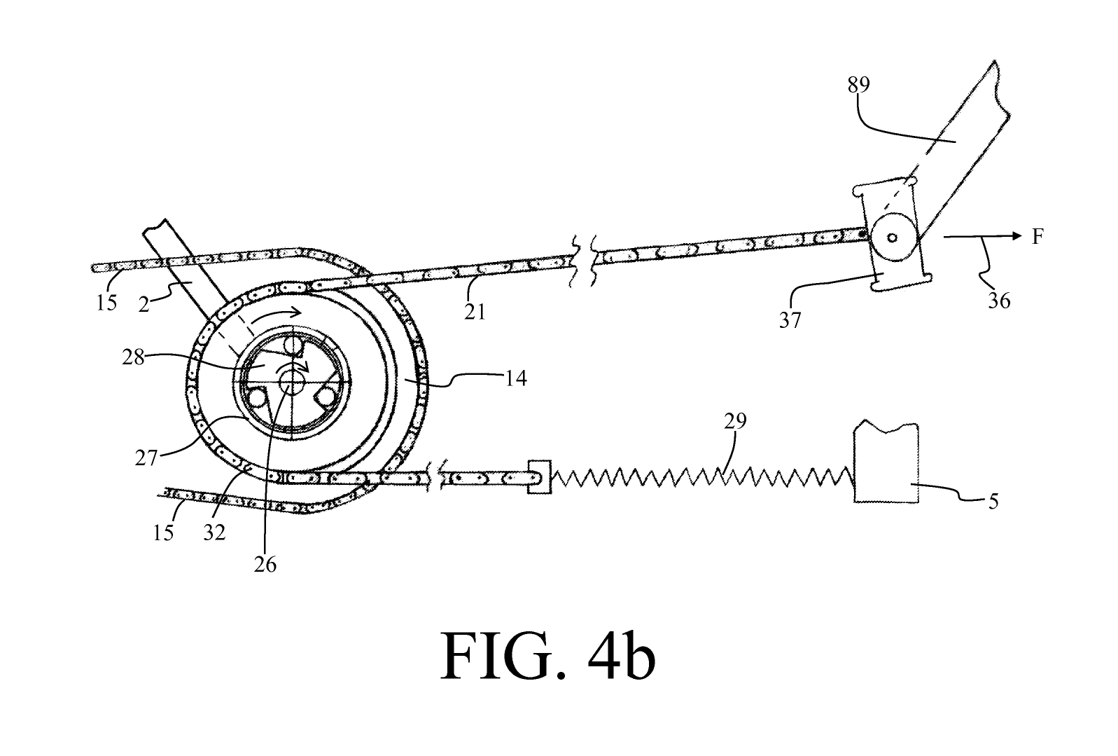

Referring to FIGS. 3A and 3B, drive mechanism 13 has a double stroke linear drive mechanism 19 and flexible power links 10 and 11. The flexible power links 10 and 11 may be made of any flexible material such as, for example, vinyl-coated metal cord 20 (FIGS. 2A, 3A, 3B) or metal chain (FIGS. 2B, 4A, 4B). While the present invention provides two specific examples of flexible power links—vinyl-coated metal cords and metal chains—useable with the linear drive mechanism described herein, the flexible power links may also be made out of any number of materials suitable to the typical stresses experienced with the use of the linear drive mechanism of the present invention. Flexible power links 10 and 11 are each partially wrapped around a one-way drum 33a and 33b similar to one-way sprocket wheels 16 that are normally found on the rear axle of bicycles.

The overrunning clutches 27 and 28 are installed on transmission axle 26, allowing drums 33a and 33b to freely rotate when no pedaling occurs. Overrunning clutches 27 and 28 engage the transmission when pedaling occurs to induce rotation of the main drive sprocket wheel 14, which is rigidly connected to transmission axle 26. The main drive sprocket wheel 14 acts like a standard forward sprocket wheel on a standard bicycle. The transmission axle 26 is located in a transmission bracket 24 and has bearings 31. To return drums 33a and 33b in a working position, flexible power link 20 performs idle motion on a return stroke cycle 35, as spiral torsion return spring 30 rotates the overrunning clutch outer ring 27 (loosely connected to drum 33a and 33b) in the opposite direction. Then the outer ring 27 performs a power stroke cycle 34 when drum 33a and 33b rotates the overrunning clutch outer ring 27 engaged with inner ring 28 and transmit the rotation to transmission axle 26, the main drive sprocket wheel 14 and the main drive chain 15. At the same time, the overrunning clutch inner ring 28 compresses a spiral torsion returning spring 30.

The left and right power stroke cycles 34 and 35 are independent from one another. Because of this independent action, the rider can use both legs simultaneously when necessary to provide more power to the vehicle, such as, for example, when accelerating, riding uphill or carrying larger loads (e.g., passengers in a rickshaw-like configuration). Likewise, the rider may alternate between left and right leg motion such as used in a typical upright or recumbent bicycle. Finally, the vehicle of this invention may be propelled with the use of either the right or left leg in a single-stroke action.

Referring to FIGS. 4A and 4B, the right power link 10 and left power link 11 may be steel chains 21 that transmit power through a power stroke 34 to sprockets 32a and 32b and rotate these sprockets by engaging the overrunning clutches 27 and 28 to induce rotation of transmission axle 26 and main drive sprocket wheel 14, which is rigidly connected to transmission axle 26 located in a transmission bracket 24 with bearings 31. To return sprockets 32a and 32b to a working position, metal chain 21 performs idle motion on a return stroke cycle 35 as a linear returning spring 29 rotates the overrunning clutch outer ring 27 (loosely connected with sprocket 32a and 32b) in the opposite direction. Then the outer ring 27 performs power stroke cycle 34 when sprocket 32a and 32b rotates the overrunning clutch outer ring 27 engaged with inner ring 28 and transmit the rotation to transmission axle 26, the main drive sprocket wheel 14 and the main drive chain 15. At the same time, the chain 15 extends the linear returning spring 29.

The torsion and linear springs used in this invention may be made of any suitable material allowing for a spring-like action, such as, for example, metal, rubber or plastic. Likewise, the vehicle of the present invention may be constructed out of typical materials used for bicycles, tricycles and other human-powered vehicles, including metal, plastic, rubber, fiberglass, and wood and wood composite materials.

Although certain figures shown herein describe a bicycle (e.g., FIG. 1), the linear drive mechanism connected by a flexible power link to a double overrunning clutch transmission with returning springs may be utilized on various recumbent human-powered vehicles such as tricycles, four-wheeled vehicles for carrying larger loads and passengers and other multi-wheel variants.

What is claimed is:

1. A recumbent human-powered vehicle propelled by a reciprocating thrust motion of an operator through the use of a reciprocating linear drive mechanism connected by at least one flexible power link to at least one overrunning clutch transmission with at least one returning spring.

2. The human-powered vehicle of claim 1, wherein the vehicle is selected from a group consisting of a bicycle, a tricycle and a four-wheeled vehicle.

3. The human-powered vehicle of claim 2, wherein the vehicle has a wheel base substantially the same as that of a conventional upright bicycle.

4. The human-powered vehicle of claim 1, wherein the vehicle further comprises:
a. a frame having a front section and a rear section, said frame including a steering column;
b. a seat mounted to the said frame;
c. an adjustable handlebar mounted to the said frame;
d. a front wheel rotatably mounted to the said frame;
e. a rear wheel rotatably mounted to the said frame, the rear wheel including a main drive sprocket wheel for power rotation of the rear wheel; and
f. a linear drive mechanism connected to a transmission for power rotation of the main drive sprocket wheel, the linear drive mechanism including a pedal operably attached to a pedal slider with a flexible power link for power rotation of an outer ring of an overrunning clutch located on a transmission axis.

5. The human-powered vehicle of claim 4, wherein the transmission further includes a plurality of drums connected to a plurality of flexible power links for performing a power stroke cycle and a return stroke cycle, wherein the drums are attached to a plurality of overrunning clutches.

6. The human-powered vehicle of claim 5, further including spiral torsion returning springs for performing the return stroke cycle.

7. The human-powered vehicle of claim 4, wherein the transmission further includes a plurality of sprockets connected to a plurality of flexible power links for performing a power stroke cycle and a return stroke cycle, wherein the sprockets are attached to a plurality of overrunning clutches.

8. The human-powered vehicle of claim 7, further including linear returning springs for performing the return stroke cycle.

9. The human-powered vehicle of claim 1, wherein the flexible power link is selected from a group consisting of cords and chains.

10. The human-powered vehicle of claim 1, wherein the vehicle may be operated with the use of both legs simultaneously.

11. The human-powered vehicle of claim 1, wherein the vehicle includes a plurality of flexible power links and a double-overrunning clutch with a plurality of returning springs.

12. A recumbent human-powered vehicle, the vehicle comprising:
a. a frame having a front section and a rear section, said frame including a steering column;
b. a seat mounted to the said frame;
c. an adjustable handlebar mounted to the said frame;
d. a front wheel rotatably mounted to the said frame;
e. a rear wheel rotatably mounted to the said frame, the rear wheel including a main drive sprocket wheel for power rotation of the rear wheel; and
f. at least one linear drive mechanism connected to a transmission for power rotation of the main drive sprocket wheel, the at least one linear drive mechanism including a plurality of pedals operably attached to a plurality of pedal sliders with a plurality of flexible power link for power rotation of a plurality of outer rings positioned on overrunning clutches located on a transmission axis, the transmission further including a plurality of returning springs for performing a return stroke cycle, the returning springs selected from a group consisting of spiral torsion returning springs and linear returning springs.

13. The human-powered vehicle of claim 12, wherein the transmission further includes a plurality of drums connected to the flexible power links for performing a power stroke cycle and a return stroke cycle.

14. The human-powered vehicle of claim 12, wherein the transmission further includes a plurality of sprockets connected to the flexible power links for performing a power stroke cycle and a return stroke cycle.

15. The human-powered vehicle of claim 12, wherein the vehicle is selected from a group consisting of a bicycle, a tricycle and a four-wheeled vehicle.

16. The human-powered vehicle of claim 15, wherein the vehicle has a wheel base substantially the same as that of a conventional upright bicycle.

17. The human-powered vehicle of claim 1, wherein the vehicle is capable of attaining speeds higher than crankshaft-operated recumbent bicycles and tricycles.

18. The human-powered vehicle of claim 12, wherein the vehicle may be operated with the use of both legs simultaneously.
